(19) United States
(12) Patent Application Publication
(10) Pub. No.: US 2002/0179742 A1
(43) Pub. Date: Dec. 5, 2002

(54) Fuel injection valve

(76) Inventors: Fevzi Yildirim, Gerlingen (DE); Guenther Hohl, Stuttgart (DE); Michael Huebel, Gerlingen (DE); Norbert Keim, Loechgau (DE)

Correspondence Address: KENYON & KENYON, ONE BROADWAY, NEW YORK, NY, 10004, US

(21) Appl. No.: 10/070,967

(22) PCT Filed: Jul. 13, 2001
(86) PCT No.: PCT/DE01/02541

(30) Foreign Application Priority Data
Jul. 15, 2000 (DE) 100 34 445.3

(51) Int. Cl. F02M 39/00

(52) U.S. Cl. 239/533.3

(57) ABSTRACT

A fuel injector, in particular an injector for fuel injection devices in internal combustion engines has a valve needle (5) with a valve-closure member (6) which cooperates with a valve seat surface (8) in a valve seat body (22) to form a sealing seat (9), in which the valve seat body (22) has a plurality of injection orifices (4, 15, 18) that are isolated from the fuel supply by sealing seat (9). The valve-closure member (6) has a pressure element (11) in a recess (10) facing the valve seat body (22), which is pre-tensioned against the valve seat body (22) by a spring (12) which is supported on the valve-closure member (6) and presses a disc spring (13) against the valve seat body (22), in such manner that the disc spring (13) covers at least one of the injection orifices (15), and the spring element (13) uncovers this injection orifice (15) when the tension exerted by the pressure element (11) is removed.

### BACKGROUND INFORMATION

The present invention relates to a fuel injector according to the definition of the species of the main claim.

German Patent Application 32 28 079 Al describes a fuel injector having two valve needles with which it is capable of controlling multiple injection orifices individually. Each valve needle is pre-tensioned against a respective sealing seat by a spring. If one needle is raised out of its sealing seat by a certain clearance, it strikes against a stop of the other valve needle and takes the second valve needle with it as the travel progresses. The two sealing seats of the two valve needles close different injection orifices, which may be directed at differing angles. However, the construction is made up of multiple parts and two sealing seats must be manufactured to precise specifications, which gives rise to high costs.

German Patent Application 30 48 304 Al describes a fuel injector for internal combustion engines having a valve needle and a secondary needle in a borehole in the valve needle. The portion of the valve needle which, near the combustion chamber is configured as a valve-closure member, cooperates with a valve seat surface to form a sealing seat that isolates injection orifices from the fuel inlet. The secondary needle which is guided in the valve needle also has a valve-closure member, which cooperates with a second valve seat surface of the fuel injector. The secondary needle is drawn towards the valve needle by a spring that is located in the valve needle, and it also forms a sealing seat against the valve needle with a valve seat surface in the valve needle. When the hydraulically actuated fuel injector begins to open as a result of rising pressure in the fuel supply line, the secondary needle is forced out of its sealing seat in the valve needle and towards the sealing seat in the valve body and closes a group of injection orifices, while another group of injection orifices is opened. If the pressure continues to rise, the valve needle is raised out of its sealing seat and after a certain travel takes the secondary needle with it, the secondary needle striking against a stop of the valve needle. All injection orifices are then opened. The disadvantage of this arrangement is that in all three sealing seats must be produced to exact specifications.

German Patent Application 31 20 044 C2 also describes a fuel injector having two valve needles, which can be used to open injection orifices in two groups. In this arrangement, one valve needle is disposed inside the other, which is constructed as a hollow valve needle. The valve needle which is designed as a hollow needle has injection orifices in its end near the combustion chamber. The disadvantage of this arrangement is that the production of the hollow needle is highly labor-intensive since it also has injection orifices, so that two functions, are combined in a single component, each requiring that the component be produced to a high degree of precision.

### ADVANTAGES OF THE INVENTION

The fuel injector according to the present invention having the characterizing features of claim 1 has the advantage over the related art due to the fact that it provides a solution for sequentially opening groups of injection orifices in a manner that is inexpensive and easily manufacturable, since the additional group of injection orifices does not require an additional sealing seat manufactured with a high degree of precision in order to be able to open separately.

In particular, the angle over which the fuel is distributed in the fuel injector's jet pattern is adjustable as a function of the valve lift.

Advantageous improvements and developments of the fuel injector described in claim 1 are possible with the measures indicated in the subordinate claims.

A first circle of injection orifices may be covered advantageously by tongues in the disc spring. Further injection orifices may have different injection angles in particular and may be offset with respect to one another by a circumferential angle. In such a case, initially when the injected volume and the load on the internal combustion engine are low, only a certain number of injection orifices having a narrow injection angle may advantageously be opened, so that a fuel injection jet is formed that is made up of fuel jets from those injection orifices having an overall narrow injection angle. As the load on the combustion engine increases and the demand on the stratified charge operation of a combustion engine running according to the lean-burn concept rises correspondingly, the injection orifices of the additional orifice circle are also opened. These may be arranged over a larger injection angle. The fuel injection jet that is injected overall is delivered over a larger angle.

### DRAWING

An embodiment of the fuel injector according to the present invention is illustrated in simplified form in the drawing and is explained in greater detail in the following description.

FIG. 1 shows a section through an embodiment of a fuel injector according to the present invention, in the unactuated state and

FIG. 2 shows a section through the embodiment of a fuel injector according to the present invention as illustrated in FIG. 1, in the actuated state and

FIG. 3 shows a top view of section along line III-III in FIG. 1.

### DESCRIPTION OF THE EXEMPLARY EMBODIMENTS

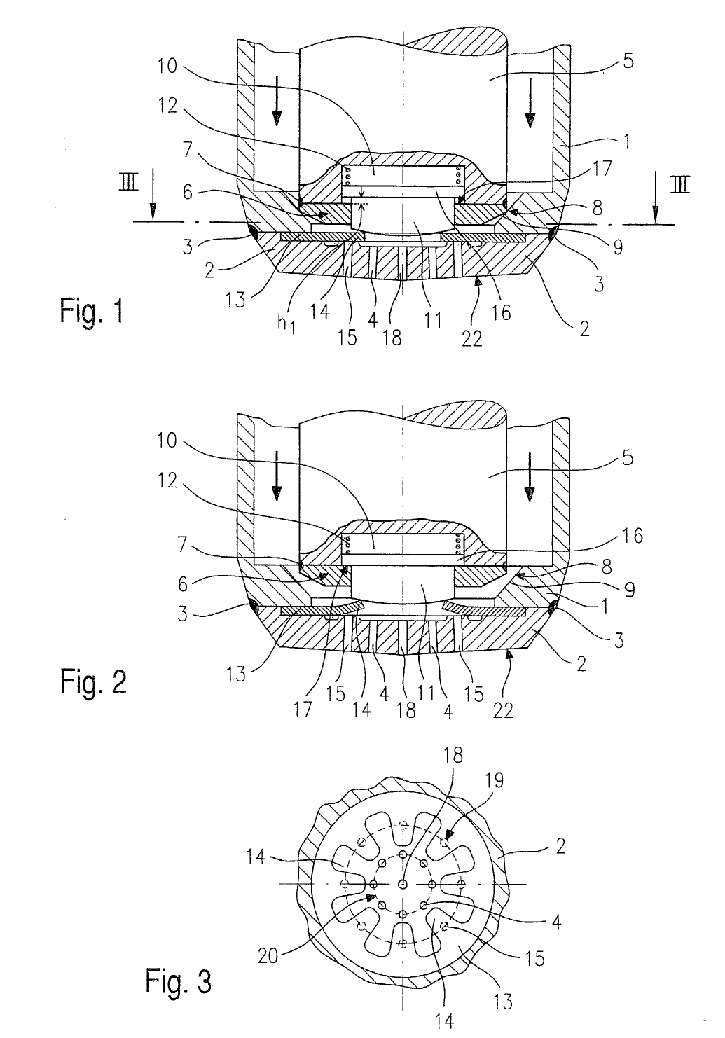

FIG. 1 shows a section through a portion of an injector according to the present invention which faces the combustion chamber (not illustrated) of an internal combustion engine.

A valve body 1 is connected by welded seam 3 to injection orifice plate 2 having injection orifices 4, and together they form valve seat body 22. The extremity of valve needle 5 facing the combustion chamber (not shown) is furnished with valve-closure member 6. This valve-closure member 6 is connected to valve needle 5 via welded seam 7. Valve-closure member 6 cooperates with valve seat surface 8 having, for example, a truncated conical shape, provided in valve body 1 to form sealing seat 9. A pressure element 11 is located in an interior recess 10 in valve needle 5, and is pressed against valve needle 5 via a spring 12. Pressure element 11, which in this embodiment has the form of a stepped cylinder, presses on a spring element, here disc spring 13, which has a plurality of tongues 14 extending radially towards the middle. Pressure element 11 presses on the inner extremity of these tongues 14. In this way, disc spring 13 is pressed onto valve seat body 22, in the illustrated embodiment towards injection orifice plate 2.

FIG. 1 shows the fuel injector in the closed state. Disc spring 13 is pressed flat by pressure element 11, deformed from its shape in the unloaded condition, and tongues 14 cover outer injection orifices 15 that are arranged beneath tongues 14.

Pressure element 11 has a collar 16 that is used as a stop. Valve-closure member 6, which is connected to valve needle 5 by welded seam 7, forms shoulder 17 in recess 10 that is used as the opposing stop. When valve needle 5 has completed partial stroke h₁, collar 16 and shoulder 17 are in contact with one another.

FIG. 2 shows the same embodiment of the present invention. The drawing represents the same cutaway section, so the same reference numbers are used to indicate the same components. In this figure, the fuel injector is in the fully open condition.

In the fully open condition, collar 16 is in contact with shoulder 17 and pressure element 11 is moved by valve needle 5. Disc spring 13 rests on valve seat body 22, in this embodiment on injection orifice plate 2. Unlike its position with the fuel injector in the closed state, as shown in FIG. 1, pressure element 11 is lifted from injection orifice plate 2 over collar 16 and shoulder 17 that rests on collar 16 by valve needle 5, and no longer exerts any pressure on tongues 14 of disc spring 13. Disc spring 13 there assumes its pre-tensioned shape and opens up injection orifices 15 that are arranged beneath tongues 14 and have been hitherto covered by tongues 14.

FIG. 3 shows a section along line III-III in FIG. 1. Injection orifices 4 and a central injection orifice 18, as well as the injection orifices 15 that are covered by tongues 14 of disc spring 13, are situated in injection orifice plate 2; in the top view, injection orifices 15 are concealed by tongues 14 and are therefore indicated by broken lines. These covered injection orifices 15 are situated in a first outer orifice circle 19 whose average circumference is indicated with a broken line. Injection orifices 4 which are not covered are arranged in a second, inner orifice circle 20, whose average circumference is also indicated with a broken line. Disc spring 13 is shown in the compressed state, corresponding to a fully closed fuel injector. In this state, all tongues 14 are in contact with injection orifice plate 2.

When the fuel injector is in the closed state, all injection orifices 4, 15 are sealed by sealing seat 9. When valve needle 5 is raised out of sealing seat 9 by an electromagnetic, piezoelectric, or magnetostrictive actuator not shown in the drawing, the fuel supply to injection orifices 4 and central injection orifice 18 is enabled, but injection orifices 15 are covered by tongues 14 of disc spring 13 and remain closed. Pressure element 11 presses tongues 14 against injection orifice plate 2 and closes covered injection orifices 15.

After partial lift h₁ (FIG. 1) of valve needle 5, collar 16 of pressure element 11 strikes against shoulder 17 in valve needle 5. As valve needle 5 continues the lift, pressure element 11 is lifted away from injection orifice plate 2. Tongues 14 deflect away from injection orifice plate 2 due to the natural tension of disc spring 13, and open injection orifices 15, which have hitherto been covered. The distance by which tongues 14 deflect upwards may be determined by the further length of the lift. However, this also influences the flow cross-section to covered injection orifices 15. If valve needle 5 is only raised by a stroke smaller than h₁, only injection orifices 4, which are not covered, are opened if the spring force of spring 12 is designed to be greater than the spring force of disc spring 13.

If the angle at which covered injection orifices 15 and uncovered injection orifices 4, 18 are disposed is varied, the overall angle of a fuel injection cone may be modified. The embodiment according to the present invention of a fuel injector advantageously enables high switching frequency; the low masses set in motion allow rapid response. The design according to the invention is also inexpensive to implement.

In a further embodiment, not represented in the drawing, disc spring 13 is shaped with suitable surfaces such that it covers not only the injection orifices of first circle 19, but also the injection orifices of second circle 20, and injection orifices 4, 15 of the different circles 19, 20 are uncovered consecutively when tension is removed, in that as tension is progressively removed, parts of disc spring 13 deflect upwards and uncover circle 20 before the reduced tension allows different parts of disc spring 13 to deflect upwards and uncover the other circle 19.

What is claimed is:

1. A fuel injector, in particular an injector for fuel injection systems in internal combustion engines comprising a valve needle (5) having a valve-closure member element (6) which cooperates with a valve seat surface (8) in a valve seat body (22) to form a sealing seat (9), a plurality of injection orifices (4, 15, 18) which are isolated from the fuel supply by the sealing seat (9) being disposed downstream from the sealing seat (9),
wherein the valve-closure member (6) has a pressure element (11) in a recess (10) facing the valve seat body (22), which applies pre-tension to a spring element (13) so that at least one of the injection orifices (15) is covered by the spring element (13), and the spring element (13) uncovers this injection orifice (15) when the tension exerted by the pressure element (11) is removed.

2. The fuel injector according to claim 1,
wherein the pressure element (11) has a stop, with which an opposing stop of the valve-closure member (6) comes into contact after a partial lift (h₁) of the valve-closure member (6) and which raises the pressure element (11) away from the valve seat body (22) with an additional lift.

3. The fuel injector according to claim 2,
wherein the stop of the pressure element (11) is a projecting collar (16) and the opposing stop of the valve closing body (6) is a shoulder (17) in the recess (10) of the valve closing body (6).

4. The fuel injector according to one of claims 1 to 3,
wherein the spring element has the form of a disc spring (13), and the disc spring (13) has tongues (14) oriented radially inward, and at least one tongue (14) covers an injection orifice (15) when the radially inner ends of the tongues (14) are pressed against the valve seat body (22) by the pressure element (11).

5. The fuel injector according to claim 4,
wherein some of the injection orifices (15) are arranged in a first circle (19) covered by tongues (14) of the disc spring (13).

6. The fuel injector according to claim 5,
wherein the valve seat body (22) is furnished with a second circle (20) of injection orifices (4), disposed radially inward from the first circle (19), and the injection orifices (4) of the second circle (20) are also covered by appropriately shaped sections on the disc spring (13).

7. The fuel injector according to claim 6,
wherein the disc spring (13) is shaped so that it uncovers injection orifices (4, 15) of the different circles (19, 20) consecutively when tension is removed.

8. The fuel injector according to one of the preceding claims,
wherein the injection orifices (4, 15, 18) have differing injection angles.

9. The fuel injector according to one of the preceding claims,
wherein the injection orifices (4, 15, 18) have differing aperture diameters and/or differing axial lengths.

10. The fuel injector according to one of the preceding claims,
wherein the valve needle (5) is actuatable using an electromagnetic or piezoelectric actuator.

11. The fuel injector according to one of the preceding claims,
wherein the injection orifices (4, 15, 18) are provided in an injection orifice plate (2) which is firmly attached to a valve body (1) having a sealing seat (9).
